(19) United States
(12) Patent Application Publication
(10) Pub. No.: US 2018/0200924 A1
(43) Pub. Date: Jul. 19, 2018

(54) METHOD AND APPARATUS FOR MANUFACTURING A MOLDED ARTICLE

(71) Applicant: Covestro Deutschland AG, Leverkusen (DE)

(72) Inventors: Chenxi Zhang, Shanghai (CN); Yuan Cheng, Shanghai (CN)

(73) Assignee: Covestro Deutschland AG, Leverkusen (DE)

(21) Appl. No.: 15/742,278

(22) PCT Filed: Jul. 12, 2016
(86) PCT No.: PCT/EP2016/066562

§ 371 Date: Jan. 5, 2018

(30) Foreign Application Priority Data
Jul. 13, 2015 (CN) 201510426424.9

(51) Int. Cl. B29C 37/00; B29B 13/08

(52) U.S. Cl. CPC B29C 37/0092; B29C 2035/0855; B29B 13/08

(57) ABSTRACT

The present invention relates to an apparatus for drying a material in a mold cavity, comprising: a microwave device for supplying microwave to the material; and a walking device disposed outside the microwave device and allows the microwave device to be movable along a guide rail disposed inside the mold cavity. The present invention also relates to a method for manufacturing a molded article, comprising: a moisture removing step, in which microwave is applied to the material in the mold cavity to phase the moisture contained in the material into vapor by means of the preceding apparatus, and then the vapor in the mold cavity is removed; and an infusing step, in which a macromolecule material resin is infused into the mold cavity under a negative pressure to manufacture the molded article.

### TECHNICAL FIELD

The present invention relates to an apparatus for drying a material in a mold cavity, and a method for manufacturing a molded article by means of the said apparatus. More specifically, the present invention relates to an apparatus for drying a material in a mold cavity by employing movable microwave device, and the method for manufacturing a molded article of materials, such as polyurethane resin, unsaturated resin, and epoxy resin, by means of the said apparatus.

### TECHNICAL BACKGROUND

Wind power, as clean and renewable energy, the development potential thereof has been recognized by countries all over the world. In China, one of the main countries in the development of wind power, each year's newly installed capacity is about 50% of that of the whole world since 2010. As expected, the accumulated installed wind power capacity in China will reach 100 GW in 2015.

Vacuum infusion technology is commonly used in the manufacture of the wind turbine blade. By using this technology, a required wind turbine blade is made of a glass fiber reinforced epoxy resin composite material by means of an ageing treatment under high temperature. However, the ageing treatment of epoxy resin requires very long time and results in low efficiency in the manufacture of the wind turbine blade.

Therefore, in order to solve the above-mentioned problem of low manufacturing efficiency, some researchers raised that polyurethane resin could be used to manufacture a wind turbine blade. A wind turbine blade made of this kind material, compared with a traditional wind turbine blade, has various advantages, such as: better mechanical performance, better fatigue resistance performance, higher interlaminar shear strength, lower product contraction rate, higher manufacturing efficiency, and less mold input cost.

However, besides the increased speed of infusion, prior to manufacturing a wind turbine blade of polyurethane resin by means of the vacuum infusion technology, moisture shall be removed and temperature shall be controlled with regard to all the materials, including glass fiber mat, balsa and etc., in the vacuum infusion mold cavity. This is because water will bring negative effects to the polyurethane resin reaction. Therefore, vapor shall be removed completely from the infusion mold cavity to prevent low manufacturing quality of a wind turbine blade.

A commonly used method for removing moisture is heating and vacuumizing the mold cavity. However, since a large wind turbine blade may have a length of 50 m to 60 m, when the common method is used to heat and to vacuumize the mold cavity, great amount of time are spent to remove the vapor completely. Moreover, this kind of heating method has various disadvantages, including: low penetration, high thermal inertia, and “remaining heat” and “over heating” phenomenon existed in the mold cavity. To achieve a process temperature suitable for the curing of polyurethane material, if “over heated”, the mold cavity usually needs to be cooled to have its temperature controlled. Otherwise, in the follow-up vacuum infusion, the curing speed of the polyurethane material will rise dramatically, and the soaking speed of glass fiber mat and the manufacturing quality of the wind turbine blade will be thus severely affected.

Therefore, above improved solution although solves the problem of long infusion time in the prior art, it brings new problem that large amount of time is cost in the moisture removing step, and thus it can not overcome the disadvantage of low manufacturing efficiency in practice.

In this regard, it is urgent to develop an apparatus for efficient and fast drying a material in a mold cavity, and a method for manufacturing a molded article by means of the said apparatus. Such method is preferred specifically suitable for large molded articles of a macromolecule material resin, such as a polyurethane resin, and may greatly reduce the time cost in the moisture removing progress without affecting the manufacturing quality of the molded articles.

### SUMMARY OF THE INVENTION

One object of the present invention is providing an apparatus for efficiently and quickly drying a material in a mold cavity.

Another object of the present invention is providing a method for manufacturing a molded article by means of the said apparatus, which is specifically suitable for large molded articles made of a macromolecule material, such as a polyurethane resin.

The first aspect of the present invention relates to an apparatus for drying a material in a mold cavity, comprising: a microwave device for supplying microwave to said material; and a walking device disposed outside the microwave device, which enables the microwave device to be movable along a guide rail disposed inside the mold cavity.

Preferably, this apparatus may further comprise a lifting device disposed on the walking device, and the lifting device is connected to the microwave device and drives said microwave device to ascend and descend between an initial position and an operation position.

More preferably, the walking device may be composed of a bracket and a plurality of rollers rotatable on the guide rail, and the microwave device may ascend and descend below the bracket by means of the lifting device.

In a specific embodiment, the microwave device may comprise: a frame connected to the lifting device; magnetrons being in communication with each other and disposed from the frame in a vertical direction; waveguides; resonant cavities; and uniform filters, the microwave generated from the magnetrons passing through the waveguides and the resonant cavities, is output from the uniform filters and then heats the material in the mold cavity.

As in illustrative examples, the magnetrons may be small domestic magnetrons having a frequency of 2540 MHz, or large industrial magnetrons having a frequency of 915 MHz.

When employing large industrial magnetrons having a frequency of 915 MHz, the waveguides may be forked waveguide combinations for guiding microwave into the resonant cavities and the uniform filters, one end of the forked waveguide combinations is connected to the resonant cavities and the other end of the forked waveguide combinations is connected to the magnetrons by means of an annular member.

Preferably, the frame may be provided with an energy-leakage preventing device around the frame for preventing microwave leakage.

Further, the microwave device may be provided with 2 to 20 sets of magnetrons.

The second aspect of the present invention relates to a method for manufacturing a molded article, comprising: moisture removing step in which microwave is applied to the material in the mold cavity to phase the moisture contained in the material into vapor by means of the above apparatus, and then the vapor in the mold cavity is removed; and an infusing step in which a macromolecule material resin is infused into the mold cavity under a negative pressure to manufacture the molded article.

Preferably, the moisture removing step may comprise: (a) descending the lifting device from the initial position, together with the microwave device connected thereon, to the operation position; (b) driving the microwave device to apply microwave to the material in the mold cavity; (c) ascending the microwave device from the operation position to the initial position by means of the lifting device when the water contents contained in the material in the mold cavity is lower than a predetermined value, and stopping operation.

Most preferably, the composite material may be polyurethane resin, unsaturation resin or epoxy resin, and the molded article may be a large scale molded article, such as a wind turbine blade or an aircraft wing.

The present invention can solve the problems such as low efficiency when the moisture contained in the materials, such as glass fiber mat and balsa, in a mold cavity in the prior art. By employing a microwave device, the moisture contained in the glass fiber mat and balsa in the mold cavity can be removed efficiently and quickly, and thus manufacturing quantity can be significantly improved and manufacturing cost is greatly lowered.

By employing a movable microwave device to remove the moisture contained in a material in a mold cavity, following technical effects can be achieved:

Because of the small thermal inertia of microwave heating, the heating of water molecules by microwave may enable the heating and temperature raising course to be completed immediately. Thus, remaining heating phenomenon will not exist in the mold cavity, which is very beneficial for automatic control and continuous heating and manufacturing.

By using microwave and vacuum drying technology, not only a glass fiber mat and balsa in a mold cavity can be dried quickly and efficiently, the overheating of the whole system can be prevented and the whole system can be maintained in a range of temperature suitable for the reaction of systems such as polyurethane resin.

### DESCRIPTION OF THE DRAWINGS

For further describing the overall structure of the apparatus for drying a material in a mold cavity according to the present invention, and the method for manufacturing a molded article by means of the said apparatus, with references to the drawings and the detailed embodiments, the present invention is described in details hereinafter, wherein, the first embodiment is showed in FIGS. 1 to 4 and the second embodiment is showed in FIGS. 5 to 7. Specifically:

FIG. 1 is an illustrative view of an overall structure of an apparatus for drying a material in a mold cavity according to the present invention from a first direction parallel to a guide rail of the mold, wherein, a microwave device comprises small domestic magnetrons having a frequency of 2540 MHz and a lifting device is in an initial position;

FIG. 2 is an illustrative view of an overall structure of an apparatus for drying a material in a mold cavity according to the present invention from a second direction perpendicular to a guide rail of the mold, wherein, a microwave device comprises small domestic magnetrons having a frequency of 2540 MHz and a lifting device is in an initial position;

FIG. 3 is an illustrative view of an overall structure of an apparatus for drying a material in a mold cavity according to the present invention from a second direction perpendicular to a guide rail of the mold, wherein, a microwave device comprises small domestic magnetrons having a frequency of 2540 MHz and a lifting device is in an operation position;

FIG. 4 shows a top view of the apparatus for drying a material in a mold cavity in FIGS. 1 to 3;

FIG. 5 is an illustrative view of an overall structure of another alternative apparatus for drying a material in a mold cavity according to the present invention from a second direction perpendicular to a guide rail of the mold, wherein, a microwave device comprises large industrial magnetrons having a frequency of 915 MHz and a lifting device is in an initial position;

FIG. 6 is an illustrative view of an overall structure of an apparatus for drying a material in a mold cavity according to the present invention from a second direction perpendicular to a guide rail of the mold, wherein, a microwave device comprises large industrial magnetrons having a frequency of 915 MHz and a lifting device is in an operation position;

FIG. 7 shows a top view of the apparatus for drying a material in a mold cavity in FIGS. 5 and 6;

FIG. 8 is an illustrative view of an implement of a vacuum infusion process.

Reference numbers

| | | |
|---|---|---|
| | 10 | walking device |
| | 11 | guide rail |
| | 13 | roller |
| | 20 | microwave device |
| | 21 | resonant cavity |
| | 22 | uniform filter |
| | 23 | magnetron |
| | 24 | waveguide |
| | 25 | microwave energy-leakage preventing device |
| | 26 | frame |
| | 28 | forked waveguide combination |
| 1 | | |
| | 28 | annular member |
| 2 | | |
| | 29 | magnetron |
| | 30 | lifting device |
| | 50 | arc-shaped mold cavity |
| | 60 | material |
| | 10 | mold |
| 1 | | |
| | 10 | prefabricated part |
| 2 | | |
| | 10 | peel ply |
| 3 | | |
| | 10 | mound flow web |
| 4 | | |
| | 10 | vacuum bag |
| 5 | | |
| | 10 | sealing tape |
| 6 | | |
| | 10 | resin tube |
| 7 | | |
| | 10 | vacuum tube |
| 8 | | |
| | 10 | vacuum pump |
| 9 | | |
| | 11 | resin catcher |
| 0 | | |
| | 11 | resin bucket |
| 1 | | |

### DETAILED DESCRIPTION

With reference to the drawings, preferable embodiments of an apparatus for drying a material in a mold cavity, and the detailed implement steps of a method for manufacturing a molded article by means of the said apparatus are described as followings.

### The First Embodiment

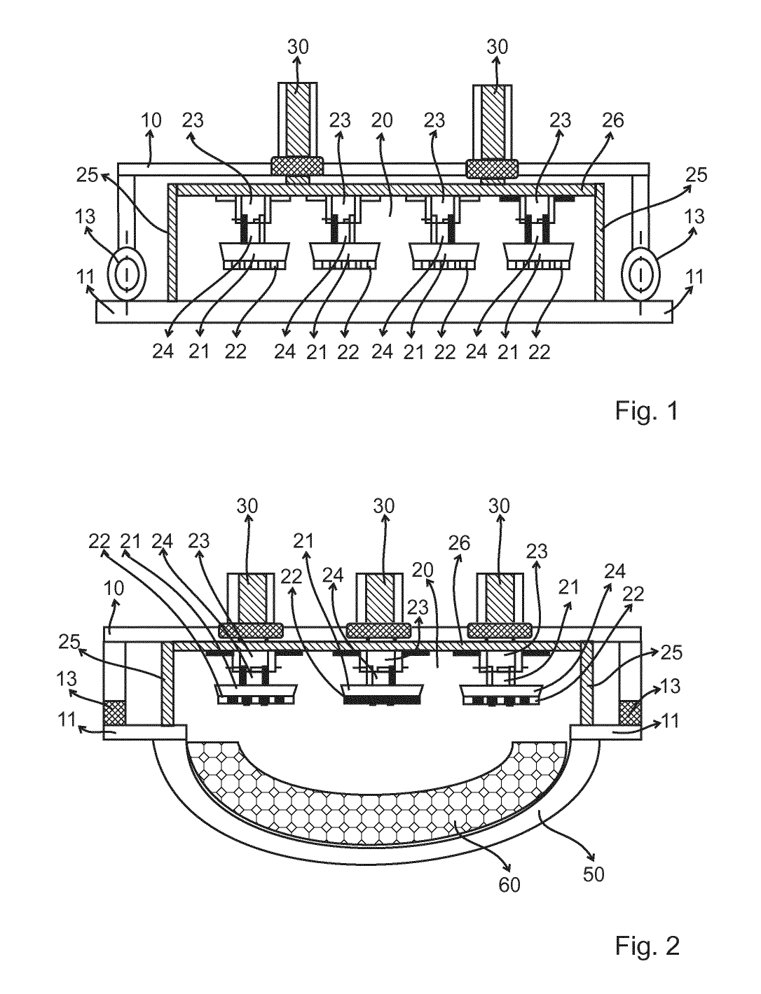

With reference to FIG. 1, FIG. 1 is an illustrative view of an overall structure of an apparatus for drying a material in a mold cavity according to the present invention. It can be seen that the said apparatus comprises: a walking device 10, a microwave device 20 and a lifting device 30. The walking device 10 is comprised of an inverted-U-shaped bracket and rollers 13 disposed at the bottom portion of the bracket. Microwave device 20 is disposed within the space surrounded by the bracket of the walking device 10, i.e. the walking device 10 is disposed outside the microwave device 20, and supplies microwave to a material in a mold cavity also disposed within the space surrounded by the bracket, so as to heat the material and vaporize the moisture contained in the material and/or vapor inside the mold cavity. Lifting device 30 is also disposed on the bracket of the walking device 10 in order to connect the microwave device 20 to the bracket by means of the listing device 30, and to drive the microwave device 20 to ascend and descend between an initial position and an operation position. As showed in FIG. 1, it can be seen that both the ascending and descending operations of the microwave device 20 are below the bracket.

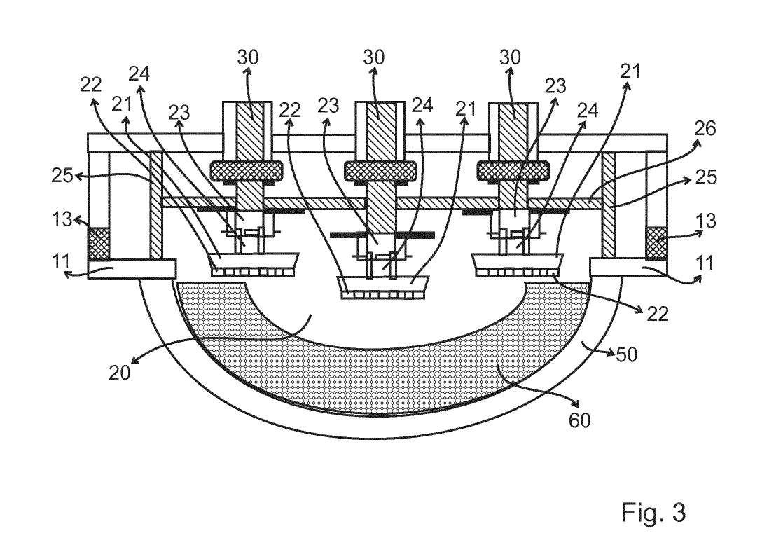

Each of FIGS. 1 to 3 shows an illustrative view of an apparatus according to the present invention placed on the guide rail 11, wherein the viewing direction of FIG. 1 is parallel to the extension direction of a guide rail 11, and the viewing directions of FIGS. 2 and 3 are perpendicular to the extension direction of the guide rail 11, i.e. the cross section of the mold cavity is showed. It can be seen that the guide rail 11 is laid on both sides of the generally arc-shaped mold cavity, so as to enable the walking device 10 to move to and fro in a straight line. A material 60, such as glass fiber mat and balsa, is distributed in the bottom part of the arc-shaped mold cavity 50.

With continued reference to FIG. 1, the microwave device 20 comprises a frame 26, and the top side of the frame 26 is connected to the lifting device 30, and a plurality of lines of microwave generating devices are installed on the bottom side of the frame 26. For example, FIG. 1 shows that four lines of microwave generating devices are installed on the frame 26, and FIGS. 2 and 3 show that each line of microwave generating devices comprises three microwave generating devices. It should be understood by person of ordinary skills in the art that different quantity of microwave generating devices may also be disposed depending on actual situation, such as, one line, three lines or five lines of microwave generating devices may be disposed, or each line of microwave generating devices may comprise two or four microwave generating devices. These embodiments shall be within the protection scope of the present invention.

Each microwave generating device comprises a magnetron 23, a waveguide 24, a resonant cavity 21, and a uniform filter 22, which are in communication with each other and disposed from the frame 26 in a vertical direction. Specifically, magnetron 23 is installed below the frame 26 so as to ascend and descend with the frame 26 and the lifting device 30 between the initial position and the operation position. An end of the waveguide 24 is in communication with the magnetron 23, so as to allow the microwave generated by the magnetron 23 to be conducted through. A microwave input port of the resonant cavity 21 is connected to the other end of the waveguide 24, while a microwave output port thereof is in communication with the uniform filter 22, so that the microwave, after passing the resonant cavity 21, is uniformly outputted from the uniform filter 22, and heats the material in the mold cavity there under.

A waveguide may be used to perform transmission tasks such as microwave transferring, connecting, coupling, redirecting. A hollow waveguide may restrain the electromagnetic field within the space of the waveguide, in order to prevent radiation loss. According their shape and function, waveguides could be sorted into straight waveguides, curved waveguides, bended waveguides, and twisted waveguides, the later three types of which are waveguides used to change a transmission direction. Microwave heating generally employs a waveguide with rectangular section in the form of a thin and long hollow metallic tube with a rectangular section. The dimension of the hollow inner space of the waveguide is a key issue to insure the transmission of high order type waves, i.e. it determines the cutoff wave length of the high order type waves transmitted thereby. The inner surface of the waveguide shall be smooth without any welding scale or cuspidal point, because any dissymmetry or anomaly will absorb the energy of the dominant mold imputed from the waveguide and then radiate again, and stimulate other molds of waves, which may cause a non-uniform electromagnetic field, and affect the heating effects significantly.

As described above, the microwave device 20 may be movable between the initial position and the operation position. As showed in FIGS. 1 and 2, when the microwave device 20 locates in the initial position, i.e. the ascended position, uniform filter 22 is away from and locates above the guide rail 11 and the material. As showed in FIG. 3, when the microwave device locates in the operation position, i.e. the descended position, the uniform filter 22 locates between the guide rail and the distance between the uniform filter 22 and the material in the mold cavity is minimal. Thus, the microwave outputted from the uniform filter 22 may have the maximal heating effects.

Furthermore, as the material, such as glass fiber mat and balsa is evenly distributed in the bottom of the arc-shaped mold cavity, thus microwave devices 20 may be designed as that the descending height of the microwave generating devices in a middle line is bigger than that in lines on both sides. Thus, the materials in the most bottom part of the mold cavity can also be heated in the maximal level.

An energy-leakage preventing device 25 is disposed around the frame 26 in order to prevent the leakage of microwave generated by the microwave generating device. The energy-leakage preventing device 25 may be designed as foldable relative to the plane of the frame 26, so as to be folded downwardly and used as a cover when necessary. Certainly, it is known to person of ordinary skills in the art that additional sealing device may also be disposed to further prevent the leakage of microwave. Such variations shall also be within the scope of protection of the present invention.

The energy-leakage preventing device 25 may comprise following types: (1) cutoff waveguide type, this type of energy-leakage preventing device utilizes the principle that microwave energy is severely attenuated in a cutoff waveguide when spreading therein; (2) waveguide groove suppression type, in this kind of energy-leakage preventing device, a group of short circuit waveguides are added at the broad edge of the input and output ports of the microwave heating component; (3) corrugated type, in this type of energy-leakage preventing device, a series of waveguide grooves with equal length are periodically arranged on the main waveguide; and (4) resistance suppression type, in this type of energy-leakage preventing device, materials with good microwave absorbing property are adhered to the end thereof in order to absorb the microwave energy.

In the present preferable embodiment, on the front and back ends of the inverted-U-shaped bracket of the walking device 10, a pair of rollers 13 rotatable on the guide rail 11 disposed inside the mold cavity are disposed respectively, so as to allow the lifting device 30 and the microwave device 20 connected below the bracket of the lifting device 30 to move to and fro along the guide rail 11. Certainly, more that one pair of rollers may also be disposed, and corresponding improvements on the structure of the walking device 10 may also be made to make the movement of the walking device 10 more stable. It is obvious to person of ordinary skills in the art, and thus detailed descriptions on this kind of improvements are omitted here in this text.

The lifting device 30 may be arbitrarily chosen from any conventional hydraulic or mechanical lifting devices sellable on the market, preferably hydraulic lifting device may be employed. Currently, conventional hydraulic or mechanical lifting devices commonly seen on the market include: (1) a hydraulic lifting device, in which a hydraulic pump is driven manually or electrically, the transmission is made by means of a hydraulic system, and a cylinder body or a piston is used as a lifting element; (2) a rack lifting device, a rack is driven manually by a level and a pinion in order to lift a frame; and (3) a screw lifting device, in which the transmission is made manually by means of a helix pair, and a screw or a nut sleeve is used as a lifting element.

A conventional screw lifting device supports loads by the self-locking effect of the thread, the structure of which is simple, however, the transmission efficiency is low and the return is slow. The thread of a self-descending lifting device has no self-locking effect, but a brake can be provided. When the brake is released, the load may descend by itself quickly so that the return time is reduced. However, the structure of the later lifting device is rather complicated. When a horizontal screw is provided on the lower part of the lifting device, the lifting device can move the load horizontally in small distance, so that the operation flexibility is improved.

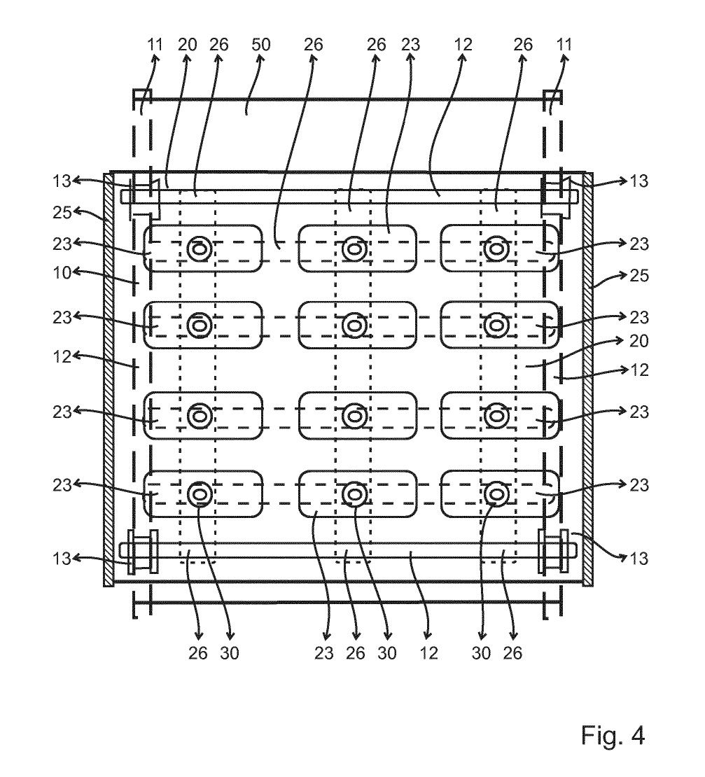

With reference to FIG. 4, FIG. 4 is a top view of the first embodiment of the apparatus of the present invention. It can be seen that the microwave device 20 employs small domestic magnetrons having a frequency of 2540 MHz and the power of the magnetrons may be from 2 KW to 5 KW. This type of magnetrons are of rather small size, and may constitute a small microwave generating device together with the waveguide 24, the resonant cavity 21, and the uniform filter 22, and may output microwave from the uniform filter 22.

In this embodiment, the microwave device 20 comprises a series of small microwave generating devices connected in series and/or in parallel. As showed in FIG. 4, the microwave device 20 includes four lines of microwave heating generating devices spacing equally, each line of the microwave generating devices comprises three microwave generating devices. Preferably, these microwave generating devices are distributed symmetrically with respect to the center line of the guide rail. In addition, microwave generating devices with larger power and/or size may be distributed as being in a position closer to the lowest part of the mold cavity; while microwave generating devices with smaller power and/or size may be distributed as being in a position farther to the lowest part of the mold cavity. According to the needs of heating speed, not only the quantity of microwave generating devices can be changed, such as 2 to 20 groups, but the power, size, and distribution distance of the microwave generating devices can also be adjusted properly.

### The Second Embodiment

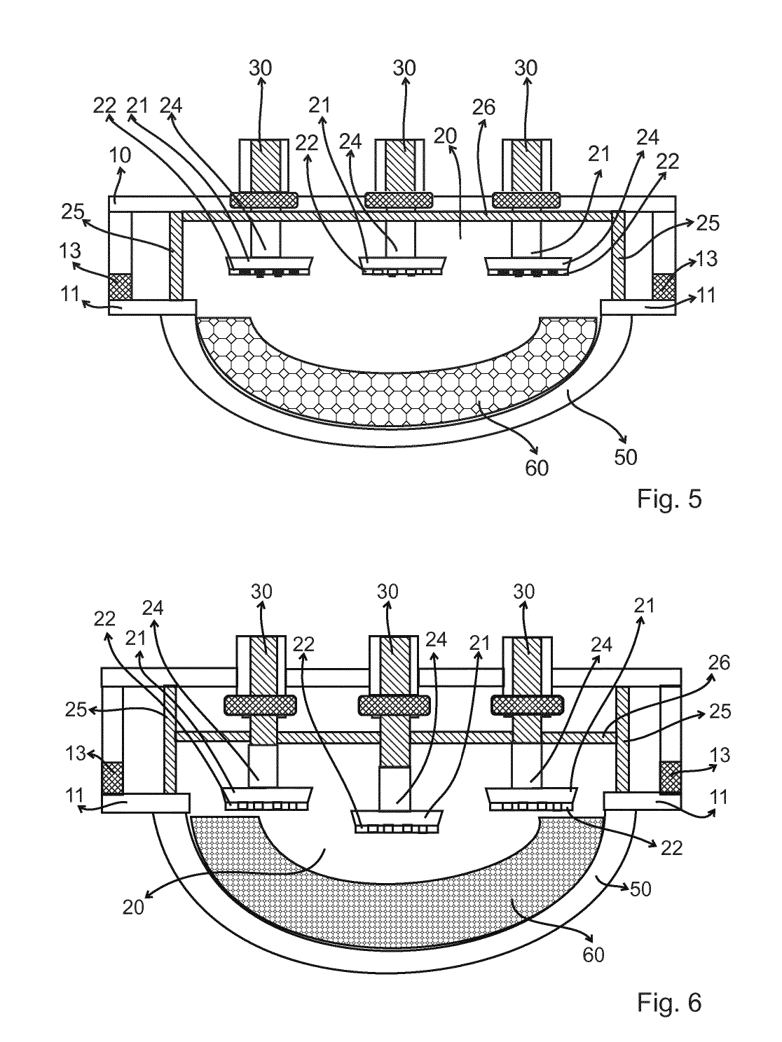

FIGS. 5-7 show a second embodiment of the apparatus for drying a material in a mold cavity according to the present invention. Only those parts different from the first embodiment are described here, while the description on the same parts is omitted.

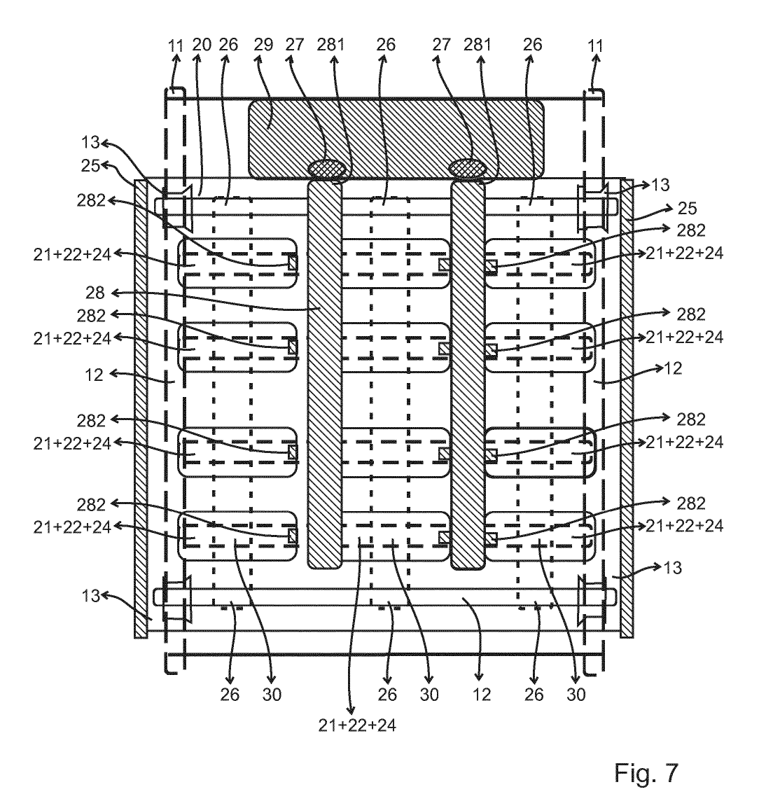

With reference to FIG. 7, in this embodiment, the microwave device 20 employs an industrial large magnetron 29 having a frequency of 915 MHz, the power of this magnetron is from 75 KW to 100 KW. Due to the huge size of the 915 MHz magnetron, in this embodiment, the magnetron 29 is disposed at the back end of the microwave device 20. Generally speaking, to prevent the waste of microwave, 2 to 4 magnetrons 29 may be connected in series and/or in parallel depending on the needs of heating speed, and microwave is guided into resonant cavities 21 and uniform filters 22 by means of forked waveguide combinations 281.

As showed in FIG. 7, one end of the forked waveguide combinations 281 is connected to the resonant cavities 21, and the other end thereof is connected to the magnetrons 29 by means of an annular member 282. In the present technical field, an annular member is a non-reversible transmission element, generally used to connect a microwave source and a resonant cavity. When the microwave power inside the resonant cavity can not be fully absorbed by the materials, part of the microwave power reflects and enters into a terminal load, such as water load, by means of the annular member, in order to prevent redundant microwave power from returning to the microwave source and damaging the magnetrons.

Because of the huge power of the magnetron 29 employed in the second embodiment, it is not necessary to provide an individual magnetron for each microwave generating device. Thus, as showed in FIGS. 5 and 6, it can be seen that the microwave generating devices in the drawings only comprises waveguides 24, resonant cavities 21, and uniform filters 22, which are in communication with each other and disposed from the frame 26 in a vertical direction.

Compared with the first embodiment, the second embodiment has the advantages of large power, high heating speed and high efficiency.

Hereinafter, the specific implementing steps for manufacturing a molded article by means of above apparatus, which mainly comprise the moisture removing step and the infusing step, are described. In the moisture removing step, microwave is applied to the material in the mold cavity to phase the moisture contained in the material into vapor by means of the apparatus of the present invention, and then the vapor in the mold cavity is removed by means of devices such as a vacuum extraction device. Specifically speaking, firstly, descending the lifting device 30 from the initial position together with the microwave device 20 connected thereon to the operation position. Then, driving the microwave device 20 to apply microwave to the material in the mold cavity to phase the moisture contained in the material into vapor. When the drying process completes, i.e. the moisture contained in the dried material is lower than a predetermined value, ascending the microwave device 20 from the operation position to the initial position by means of the lifting device 30 and stopping operation. In the infusing step, a macromolecule material resin is infused into the mold cavity under a negative pressure to manufacture the molded article by means of processes such as a vacuum infusion process.

It is easy to be understood by person of ordinary skills in the art that above-mentioned macromolecule material resin may be polyurethane resin, unsaturation resin or epoxy resin. These resins are relatively more suitable for manufacturing a large molded article, such as a wind turbine blade or an aircraft wing. Certainly, large scale molded articles used in the fields of water vehicle, such yachts and fishing boats, and rail vehicle shall also be the objects manufactured according to the method of the present invention.

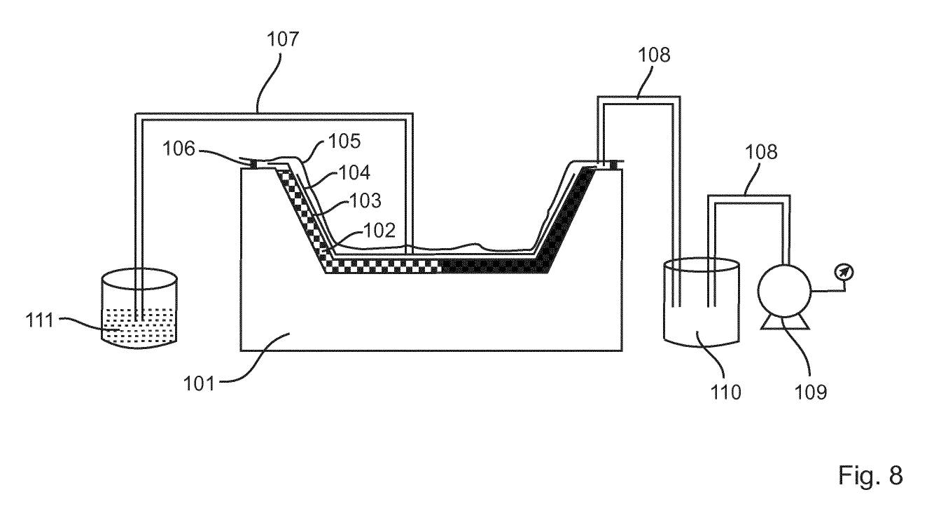

With reference to FIG. 8, FIG. 8 shows an illustrative view of an implement of a vacuum infusion process. The vacuum infusion process is a molding technology widely used in manufacturing articles of a fiber reinforced resin composite material, and the conventional process procedure of which is introduced briefly as followings: laying certain layers of fiber prefabricated parts 102 on a mold 101 according to the design requirement. The prefabricated parts 102 may comprise a core material such as foam, balsas, or other reinforcing material. Laying components such as a peel ply 103, a mould flow web 104, a resin tube 107 and a vacuum tube 108 on the prefabricated parts 102. Then sealing the prefabricated parts 102 and the related components by a vacuum bagging film 105 and a sealing tape 106 in order to form a completely airtight system. Connecting a vacuum tube 108 to a resin catcher 110, and further connecting to a vacuum pump 109 in order to extract air in the airproof system until achieving a vacuum pressure of −0.05 MPa to −0.1 MPa.

When the moisture contained in the prefabricated parts 102 in the mold cavity and in the core materials such as foam, balsa, or any other reinforcing material in the prefabricated parts 102 is phased into vapor by microwave, vapor in the mold cavity can be extracted by means of the above vacuum process. When the vapor has been extracted, inserting the resin tube 107 into an open resin bucket 111 filled with resin, and the resin will be sucked into above airtight system due to the vapor and the effect of atmospheric pressure and will oak the prefabricated parts 102 quickly with the help of the mold floe web 104. Redundant resin will be sucked through the vacuum tube 108 and collected in the resin catcher 110. Then, according to the property of the resin used, curing the resin in room temperature or by heating the mold. In the end, removing the components such as the peel ply 103, the mould flow web 104, the resin tube 107 and the vacuum tube 108, and taking the cured article out of the mold to obtain the final product.

Although the structure of the apparatus of the present invention and the method for manufacturing a molded article by means of the said apparatus are described above with references to the preferable embodiments, person of ordinary skills in the art shall recognize that above examples are only for illustrative purpose and will not limit the present invention. For example, small magnetrons 23 and large magnetrons 29 can be used in combination, and other moisture removing devices may be employed in place of the vacuum extraction device. Therefore, variations are available within the scope of the substantial spirit of the claims. These variations shall all fall within the scopes claimed by the claims of the present invention.

1. An apparatus for drying a material in a mold cavity, wherein said apparatus comprises:
a microwave device for supplying microwave to said material; and
a walking device disposed outside said microwave device, said microwave device being movable along a guide rail disposed inside said mold cavity.

2. The apparatus according to claim 1, further comprising a lifting device disposed on said walking device, said lifting device (30) is connected to said microwave device and drives said microwave device to ascend and descend between an initial position and an operation position.

3. The apparatus according to claim 2, wherein said walking device is comprised of a bracket and a plurality of rollers rotatable on said guide rail, said microwave device is ascended and descended below said bracket by means of said lifting device.

4. The apparatus according to claim 1, wherein said microwave device comprises: a frame connected to said lifting device; magnetrons in communication with each other and disposed from said frame in a vertical direction; waveguides; resonant cavities; and uniform filters, wherein the microwave generated from said magnetrons passes through said waveguides and said resonant cavities, output from said uniform filters, and then heats said material in said mold cavity.

5. The apparatus according to claim 4, wherein said magnetrons have a frequency of 2540 MHz.

6. The apparatus according to claim 4, wherein said magnetrons have a frequency of 915 MHz.

7. The apparatus according to claim 6, wherein said waveguides are forked waveguide combinations for guiding microwave into said resonant cavities and said uniform filters, wherein one end of said forked waveguide combinations is connected to said resonant cavities and the other end of said forked waveguide combinations is connected to said magnetrons by means of an annular member.

8. The apparatus according to claim 4, wherein said frame is provided with an energy-leakage preventing device for preventing microwave leakage around said frame.

9. The apparatus according to claim 1, wherein said microwave device is provided with 2 to 20 sets of magnetrons.

10. A method for manufacturing a molded article, comprising:
removing moisture by applying microwave to said material in said mold cavity to phase the moisture contained in said material into vapor by means of the apparatus according to claim 1, and then removing the vapor in said mold cavity; and
infusing a macromolecule material resin into said mold cavity under a negative pressure to manufacture said molded article.

11. The method according to claim 10, wherein said removing moisture step further comprising:
(a) descending said lifting device from said initial position, together with said microwave device connected thereon, to said operation position;
(b) driving said microwave device to apply microwave to said material in said mold cavity;
(c) ascending said microwave device from said operation position to said initial position by means of said lifting device when the water contents contained in said material in said mold cavity is lower than a predetermined value, and stopping operation.

12. The method according to claim 10, wherein said macromolecule material resin is selected from the group consisting of polyurethane resin, unsaturation resin, and epoxy resin.

13. The method according to claim 10, wherein said molded article is selected from the group consisting of a wind turbine blade, and an aircraft wing.
